(19) United States
(12) Patent Application Publication
(10) Pub. No.: US 2010/0316531 A1
(43) Pub. Date: Dec. 16, 2010

(54) MICROFLUIDIC DEVICE INCLUDING TWO HYDROPHOBIC LAYERS ASSEMBLED TOGETHER AND ASSEMBLY METHOD

(75) Inventors: Cyril Delattre, Izeaux (FR); Frédéric Bottausci, Saint-Aygulf (FR)

Correspondence Address: Nixon Peabody LLP, P.O. Box 60610, Palo Alto, CA, 94306, US

(73) Assignee: COMMISSARIAT A L'ENERGIE ATOMIQUE ET AUX ENERGIES ALTERNATIVES, Paris (FR)

(21) Appl. No.: 12/813,450

(22) Filed: Jun. 10, 2010

(30) Foreign Application Priority Data
Jun. 11, 2009 (FR) 09 53880

(51) Int. Cl. G01N 27/00; B32B 37/12

(52) U.S. Cl. 422/82.02; 422/68.1; 156/329

(57) ABSTRACT

A microfluidic device comprising first and second substrates respectively including first and second hydrophobic layers based on polysiloxane, said hydrophobic layers each comprising an assembly area. The substrates are assembled with each other at said assembly areas by means of an adhesive based on silicone.

### CROSS REFERENCE TO RELATED APPLICATIONS OR PRIORITY CLAIM

This application claims priority of French Patent Application No. 09 53880, filed Jun. 11, 2009.

### DESCRIPTION

1. Technical Field

The present invention relates to the general field of microfluidics as well as to that of the assembling of hydrophobic layers, required for forming microfluidic devices such as lab-on-a-chip for example.

The invention relates to a microfluidic device including two hydrophobic layers assembled with each other. It also relates to a method for assembling said hydrophobic layers.

The invention applies to any device with continuous microfluidics or discrete microfluidics, or with drops, notably giving the possibility of forming, displacing, mixing, storing small volumes of fluids with view to biochemical, chemical or biological analyses, whether in the medical field or in environmental monitoring, or in the field of quality control.

2. State of the Prior Art

With a microfluidic device, liquid samples of small volume, for example drops of a few nanoliters or a few microliters may be handled.

Such a device may appear in an open configuration where the samples are handled at the surface of the substrate, or in a closed configuration wherein the samples are confined between a lower substrate and an upper substrate or cap.

FIG. 1 shows an exemplary microfluidic device in a closed configuration. It should be noted that scales are not observed in order to favor clarity of the drawing.

The lower substrate 1 comprises a dielectric supporting layer 10 provided with a matrix of independent electrodes 11.

Each of these electrodes 11 is electrically connected to a conductor and may be electrically powered independently of each other, through an addressing means (not shown).

The electrodes 11 are covered with a dielectric layer 12 and a hydrophobic layer 13, forming a displacement surface 14.

The substrate 1 is sealably assembled to a cap 2.

The cap 2 conventionally comprises a dielectric closure layer 20 on which a counter-electrode 21 is positioned, covered with a hydrophobic layer 23.

Thus, with the device by successively powering the electrodes 11, it is possible to displace a small volume of liquid G as a drop following a path defined by the arrangement of the electrodes 11. The drop G is surrounded by an immiscible and non-conducting fluid F.

The forces used for the displacement are electrostatic forces.

The method for displacement or handling is based on the principle of electrowetting on a dielectric, as described in the article of Pollack et al. entitled <<Electrowetting-based actuation of droplets for integrated microfluidics>>, Lab. Chip 2 (1) 2002, pages 96-101. This document also shows examples of microfluidic devices in a closed configuration.

In order to specifically define the distance which separates the cap 2 from the substrate 1 and to delimit a sealed microfluidic cavity, spacers 30 or walls may be formed or deposited on the dielectric layer 12 and positioned in proximity to the border of the substrate 1.

It should be noted that, according to an alternative embodiment, the walls 30 may be integrally formed with the supporting layer 10 of the substrate 1, the latter then being microstructured.

By “integrally formed” is meant “formed all in one block”, or “formed in a single piece”.

The hydrophobic layer 13 is arranged so as to cover the dielectric layer 12 of the substrate 1 as well as at least partially the surface of the walls 30. At the cap 2, the hydrophobic layer 23 covers the counter-electrode 21.

The assembly of the substrate 1 and of the cap 2 is carried out at their respective hydrophobic layers 13, 23. More specifically, each hydrophobic layer 13, 23, has a surface including a displacement area 14, 24 which participates in delimiting the microfluidic cavity and an assembly area 15, 25 intended to be assembled with the corresponding assembling area of the second hydrophobic layer.

A certain number of difficulties appear during the assembling of the substrate and of the cap at the hydrophobic layers.

Indeed, the hydrophobic layers are usually made in fluorinated polymer, for example Teflon® or polytetrafluoroethylene (PTFE) marketed by DuPont, or Cytop® produced by Asahi Glass, or made in polydimethylsiloxane (PDMS).

Now, it is known that adhesives do not sufficiently adhere onto this type of material, which makes direct adhesive bonding difficult or even impossible between the hydrophobic layer 13 of the substrate 1 and that 23 of the cap 2, at their respective assembly areas 15, 25.

Also, during the assembling of said surfaces 15, 25, it is standard to carry out a surface treatment step, prior to the adhesive bonding step, in order to modify the hydrophobic properties and/or the roughness of the surface of the hydrophobic layers 13, 23.

A surface treatment by chemical etching may be carried out, for example with the product <<Fluoroetch®>> marketed by Acton Technologies. It is also possible to carry out a treatment by physical etching with an argon plasma, as described in the article of S.-R. Kim entitled <<Studies on the surface changes and adhesion of PTFE by plasma and ion beam treatments>> and published in 1999 in Korea Polymer Journal, 1999, 7(4), 250 [1].

This surface treatment step makes adhesive bonding possible of the hydrophobic layers 13, 23 at their respective assembly areas 15, 25, and the use possible of any type of adhesive adapted to the surface.

However, the use of these materials for the hydrophobic layers entails a certain number of drawbacks.

On the one hand, as this has just been explained, a surface treatment step is required for allowing adhesive bonding, which lengthens and complicates the method for making the microfluidic device. The production cycle is then penalized in terms of cost and time.

Next, the surface treatment cannot be simply localized to the sole assembly areas 15, 25. Indeed, the displacement areas 14, 24 of the hydrophobic layers 13, 23 are also impacted by the chemical or physical etching surface treatment, which reduces the wettability properties of the hydrophobic layer in these areas. More specifically, its hydrophobicity is reduced, and its roughness is increased (and therefore the wetting hysteresis), which is greatly detrimental to the efficiency and reproducibility of the displacement of the drops by electrowetting.

It should be noted that roughness may be defined as the arithmetic mean of the absolute values of the vertical deviations of the surface relatively to a mean value.

Finally, with the techniques usually used for deposition of polydimethylsiloxane (PDMS), of Teflon® and of other fluorinated materials, for example spin-coating and dip-coating, a layer of homogeneous thickness cannot be obtained on surfaces having raised structures, such as walls 30, which is detrimental for displacement of the drops.

An alternative to the materials cited earlier is to use, in order to form the hydrophobic layer, a polysiloxane of the SiOC type, notably as described in patent application WO 2007/003754 A1 filed in the name of the applicant.

As described by this document, SiOC may be deposited by plasma-enhanced chemical vapor deposition (PECVD). The wettability properties of the material are obtained from selecting the precursor and the PECVD deposition characteristics.

The use of SiOC in microfluidic devices is described in the article of Thery et al. entitled <<SiOC as a hydrophobic layer for electrowetting on dielectric applications>> and presented during the Eleventh International Conference on Miniaturized Systems for Chemistry and Life Sciences (μTAS2007), 7-11 Oct. 2007, Paris, France.

Unlike the techniques for depositing fluorinated polymers or PDMS, the technique for depositing SiOC by PECVD is particularly adapted to surfaces having high aspect ratios.

However, the hydrophobicity properties of this material are particularly sensitive to the surface treatments usually required for adhesively bonding both hydrophobic layers.

A treatment by chemical or physical action as described earlier indeed causes significant degradation of the hydrophobicity of the layer, and makes the displacement of the drops quasi impossible.

An alternative to this surface treatment step is then to tighten the cap and substrate against each other, at the assembly areas of the hydrophobic layers.

It should then be noted that the cap and the substrate are assembled with each other without the hydrophobic layers being themselves assembled with each other. The latter are in simple mutual contact at their assembly area.

Moreover, with this tightening technique, it is not possible to obtain a perfectly sealed microfluidic cavity.

### DISCUSSION OF THE INVENTION

The main object of the invention is to present a microfluidic device comprising first and second substrates including, first and second hydrophobic layers based on polysiloxane, respectively, at least partially finding a remedy to the drawbacks mentioned above relating to the making of the prior art described with reference to FIG. 1.

To do this, the object of the invention is a microfluidic device comprising first and second substrates respectively including first and second hydrophobic layers based on polysiloxane, said hydrophobic layers each comprising an assembly area.

According to the invention, said substrates are assembled with each other at the assembly areas of said hydrophobic layers by means of an adhesive based on silicone.

Thus, a silicone-based adhesive allows the assembling of said substrates of the microfluidic device, without altering the hydrophobic properties of said hydrophobic layers.

The invention is thus distinguished from the prior art as described earlier, notably by the fact that in the prior art, the hydrophobic properties of said hydrophobic layers are necessarily altered in order to achieve the assembling of the substrate.

Preferably, each first and second substrate forms a solid substantially incompressible.

Advantageously, said first substrate includes at least one wall arranged so as to delimit, together with said second substrate, a microfluidic cavity for fluid displacement, said wall being at least partially covered with said first hydrophobic layer.

Advantageously, said first hydrophobic layer comprises a first surface forming a surface of fluid displacement, a second surface forming said assembly area and located at said wall, and a third surface connecting said first and second surfaces and located at said wall.

Said first surface, named surface of fluid displacement, of the first hydrophobic layer is located inside said microfluidic cavity.

Said third surface, named connecting surface, of the first hydrophobic layer extends between said first and second surfaces of the first hydrophobic layer. It is then located on a internal side of the wall, more specifically inside the microfluidic cavity.

Said third surface may extend substantially orthogonally with respect to said first and second surfaces of the first hydrophobic surface.

Said wall may be an added element arranged at said first substrate or may be integrally formed with said first substrate.

Said second hydrophobic layer comprises a first surface forming a fluid displacement surface and a second surface forming said assembly area, said first and second surfaces of said second hydrophobic layer facing said first and second surfaces of said first hydrophobic layer, respectively.

Said first hydrophobic layer may be deposited at the surface of the first substrate and of the wall by plasma-assisted chemical vapor deposition. This layer advantageously presents a substantially homogeneous thickness, notably at said first, second and third surface thereof. The displacement of droplets is then substantially homogeneous on the whole surface of displacement.

The invention is thus distinguished from the prior art as described earlier in which the first hydrophobic layer, when deposited by spin-coating or by dip-coating on surfaces having raised structures, cannot present a homogeneous thickness, which is detrimental for displacement of the droplets.

During the step for depositing the first hydrophobic layer on the first substrate and notably on the wall by plasma-assisted chemical vapor deposition, said first hydrophobic layer is at least partially deposited on the upper face of the wall, said upper face being oriented towards the second substrate. This part of first layer forms the assembly area of the first hydrophobic layer, at which the substrates are assembled with each other.

Thus, by means of an adhesive based on silicone, the assembly of said substrates at the assembly areas is made possible. A microfluidic cavity for fluid displacement, also named closed microfluidic circuitry, can be obtained.

Advantageously, said hydrophobic layers are based on a polysiloxane for which the ratio between the linear —Si—O— bonds and the cyclic —Si—O— bonds is less than or equal 0.4, or preferably less than or equal to 0.3. This material has low wetting hysteresis and a hydrophobic surface. The wetting hysteresis of said first hydrophobic layer may thus be less than 10° or less than 5°.

The term of adhesive is meant here as a synonym of glue.

By silicone is meant a polyorganosiloxane.

Said adhesive is preferably a silicone elastomer.

Said adhesive may be based on a one-component or multi-component silicone. Advantageously, said adhesive is based on fluorosilicone.

According to a preferred embodiment of the invention, said adhesive is positioned between the assembly areas of said hydrophobic layers.

According to another preferred embodiment of the invention, the assembly areas of said hydrophobic layers are at least partially in mutual contact, said adhesive being located at the outer periphery of the joint of said assembly areas.

Preferably, said first substrate and said second substrate form together a microfluidic cavity for displacement of fluid. Said first hydrophobic layer extends at the surface of said first substrate and said second hydrophobic layer extends at the surface of the second substrate so as to at least partially delimit said microfluidic cavity. Preferably, the microfluidic cavity is entirely delimited by said first and second hydrophobic layers.

Preferably, said first substrate comprises an array of electrodes covered with a dielectric layer, said first hydrophobic layer covering said dielectric area, and in that said second substrate comprises a counter-electrode.

Alternatively, said first substrate comprises a counter-electrode covered with said first hydrophobic layer, and said second substrate comprises an array of electrodes covered with a dielectric layer, said second hydrophobic layer covering said dielectric area.

The invention also relates to a method for assembling first and second substrates with each other, said substrates respectively including first and second hydrophobic layers based on polysiloxane, said hydrophobic layers each comprising an assembly area, said method being characterized in that it comprises a step for adhesively bonding said substrates to each other at the assembly areas of said hydrophobic layers by means of an adhesive based on silicone.

Said hydrophobic layers may be formed, prior to said adhesive bonding step, by dip-coating or spin-coating, or formed by chemical vapor deposition (CVD).

Preferably, said first and second hydrophobic layers are respectively formed at the surface of said first and second substrates by plasma-assisted chemical vapor deposition, into which a precursor selected from cyclic organosiloxanes and cyclic organosilazanes is injected, the ratio between the power density dissipated in the plasma and the flow rate of the precursor injected into the plasma being less than or equal to 100 W·cm⁻²/mol·min⁻¹.

In the case of chemical vapor deposition, the precursor is advantageously selected from octamethylcyclotetrasiloxane and its derivatives, or from octamethylcyclotetrasilazane and its derivatives. Said precursor used may also be selected from hexamethyldisiloxane and its derivatives, trimethylsilane and its derivatives, tetramethylsilane and its derivatives, bis-trimethylsilylmethane and its derivatives.

Moreover, the precursor is advantageously diluted in a neutral or oxidizing gas before being injected into the plasma, for example nitrogen, oxygen, helium or further and preferably hydrogen.

Advantageously, said step for adhesively bonding said substrates is directly preceded with said step for depositing said first and second hydrophobic layers at the surface of said first and second substrates, respectively. Indeed, it is not necessary to carry out, as in the examples of the prior art described earlier, a surface treatment step by chemical or physical etching which alters the hydrophobic properties of the hydrophobic layers.

Preferably, said first substrate comprises at least one wall arranged so as to delimit, together with said second substrate, a microfluidic cavity for fluid displacement, said step for depositing said first hydrophobic layer being carried out so that said wall is at least partially covered with said first hydrophobic layer.

Preferably, said adhesive bonding step comprises a step for vulcanization of said adhesive with release of acetic acid.

Other advantages and features of the invention will become apparent in the non-limiting detailed description below.

### SHORT DESCRIPTION OF THE DRAWINGS

Now, as non-limiting examples, embodiments of the invention will be described with reference to the appended drawings wherein:

FIG. 1, already described in connection with an exemplary microfluidic device according to the prior art, is a schematic longitudinal sectional view of a microfluidic device having a microfluidic cavity notably delimited by added sidewalls. FIG. 1 also illustrates a first preferred embodiment of the invention;

FIG. 2 is a schematic longitudinal sectional view of a microfluidic device according to a second preferred embodiment of the invention having a microfluidic cavity notably delimited by sidewalls integrally formed with the lower substrate;

FIG. 3 is a schematic longitudinal sectional view of a microfluidic device, according to a third preferred embodiment of the invention, wherein the adhesive is positioned at the outer periphery of the juncture of the hydrophobic layers;

FIGS. 4 and 5 are curves illustrating the time-dependent change of the pressure inside a microfluidic cavity of the microfluidic device according to the invention versus the number of imposed pressure increase increments.

### DETAILED DISCUSSION OF A PREFERRED EMBODIMENT

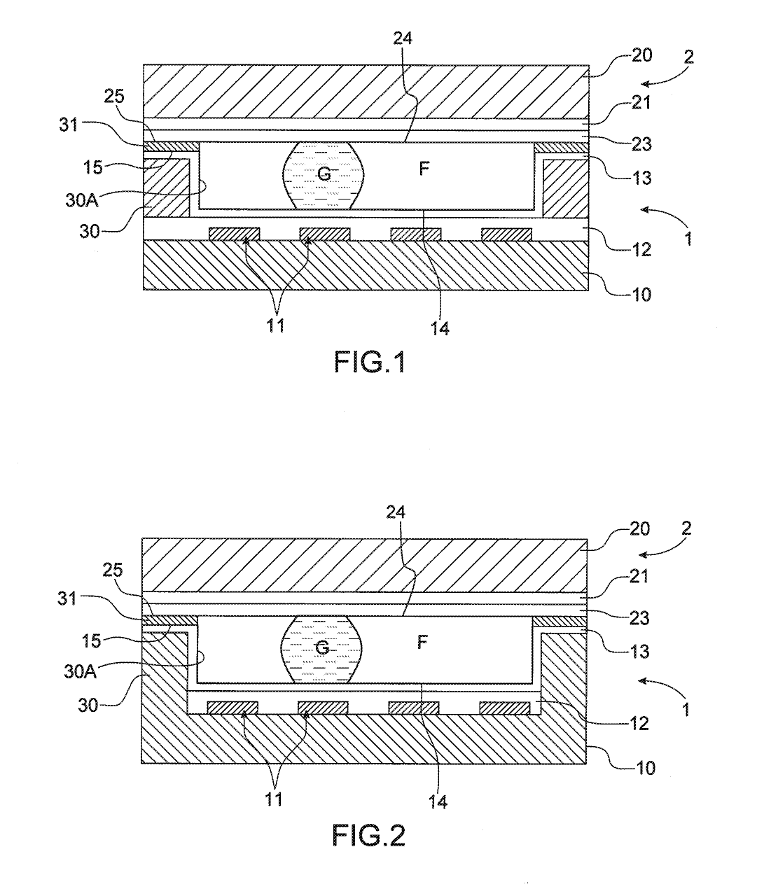

FIGS. 1-3 illustrate a microfluidic device according to three preferred embodiments of the invention.

FIG. 1 was described earlier with reference to an example of the prior art. It also illustrates the structure of the microfluidic device according to a first preferred embodiment of the invention.

As described above in reference to one example of the prior art, the lower substrate 1 comprises a dielectric supporting layer 10 provided with a matrix of independent electrodes 11.

Each of these electrodes 11 is electrically connected to a conductor and may be electrically powered independently of each other, through an addressing means (not shown).

The electrodes 11 are covered with a dielectric layer 12 and a hydrophobic layer 13, forming a displacement surface 14.

The substrate 1 is sealably assembled to a cap 2.

The cap 2 conventionally comprises a dielectric closure layer 20 on which a counter-electrode 21 is positioned, covered with a hydrophobic layer 23.

Thus, with the device by successively powering the electrodes 11, it is possible to displace a small volume of liquid G as a drop following a path defined by the arrangement of the electrodes 11. The drop G is surrounded by an immiscible and non-conducting fluid F.

The forces used for the displacement are electrostatic forces.

The method for displacement or handling is based on the principle of electrowetting on a dielectric, as described in the article of Pollack et al. entitled <<Electrowetting-based actuation of droplets for integrated microfluidics>>, Lab. Chip 2 (1) 2002, pages 96-101. This document also shows examples of microfluidic devices in a closed configuration.

In order to specifically define the distance which separates the cap 2 from the substrate 1 and to delimit a sealed microfluidic cavity, spacers 30 or walls may be formed or deposited on the dielectric layer 12 and positioned in proximity to the border of the substrate 1.

The microfluidic device has a microfluidic cavity notably delimited by added sidewalls.

By added wall, is meant a wall which does not belong to the structure of another element of the device, here the supporting layer of the substrate 1, as described later on.

The hydrophobic layer 13 is arranged so as to cover the dielectric layer 12 of the substrate 1 as well as at least partially the surface of the walls 30. At the cap 2, the hydrophobic layer 23 covers the counter-electrode 21.

The assembly of the substrate 1 and of the cap 2 is carried out at their respective hydrophobic layers 13, 23. More specifically, each hydrophobic layer 13, 23, has a surface including a displacement area 14, 24 which participates in delimiting the microfluidic cavity and an assembly area 15, 25 intended to be assembled with the corresponding assembling area of the second hydrophobic layer.

The first hydrophobic layer 13 also comprises a connecting surface 30A extending between the displacement area 14 and the assembly area 15. The first hydrophobic layer 13 thus comprises a first surface 14 forming the displacement surface, a second surface 15 forming said assembly area and located at said wall 30, and a third surface 30A connecting said first and second surfaces 14, 15 and located at said wall 30.

FIG. 2 only differs from FIG. 1 insofar that the walls are integrally formed with the supporting layer of the lower substrate 1. It illustrates a second preferred embodiment of the invention.

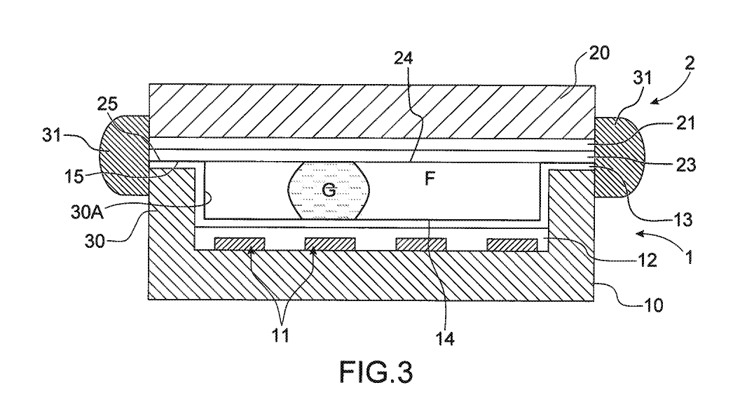

FIG. 3 illustrates a third preferred embodiment of the invention, which essentially differs from the second preferred embodiment by the position of the adhesive.

In FIGS. 2 and 3, numerical references identical with those of FIG. 1 indicate identical or similar elements.

According to these embodiments, the hydrophobic layers 13, 23 are made from a polysiloxane.

By polysiloxane, is meant a polymer for which the macromolecular backbone is based on the —Si—O— linking and the ratio between the number of linear —Si—O— bonds and the number of cyclic —Si—O— bonds is noted as r.

Preferably, the ratio r is less than or equal to 0.4 or advantageously less than or equal to 0.3.

The material based on polysiloxane with such a conformation, is obtained by plasma-assisted chemical vapor deposition, also called PECVD, as described in the application WO 2007/003754 A1 filed in the name of the applicant, so that said material has significant hydrophoby and low contact angle hysteresis. Preferably, said hydrophobic layers 13, 23 do not have elastic properties.

As described earlier, the hydrophobic layer 13 covers, at the substrate 1, the dielectric layer 12 and the internal faces of the walls 30.

The hydrophobic layer 23 of the cap 2 may either cover or not the counter-electrode 21. The counter-electrode 21 may be a planar electrode, a wire or a track deposited at the surface of the closure layer 20, or buried in this layer 20, or deposited at the surface of the hydrophobic layer 23.

Each hydrophobic layer 13, 23 comprises an assembly area 15, 25 positioned facing each other.

The substrate 1 and the cap 2 are assembled with each other at the assembly areas 15, 25 of the hydrophobic layers 13, 23.

The assembling is carried out by means of an adhesive 31 based on silicone.

The term of adhesive is used here as a synonym of glue. Said adhesive is preferably a silicone elastomer.

According to the first and second preferred embodiments of the invention (FIGS. 1 and 2), the adhesive 31 based on silicone is placed between the assembly areas 15, 25 of the hydrophobic layers 13, 23 and in contact with the latter.

In the third preferred embodiment of the invention (FIG. 3), the hydrophobic layers 13 and 23 are at least partially in contact with each other at the assembly areas 15, 25. The adhesive 31 is then positioned at the outer periphery of the juncture of said assembly areas 15 and 25. More specifically, the adhesive 31 is positioned against the substrate 1 and the cap 2 in contact with the outer periphery of the hydrophobic layers 13 and 23 at the assembly areas 15 and 25. Thus, the adhesive 31 is not localized between the hydrophobic layers 13 and 23.

In these three preferred embodiments of the invention, the adhesive 31 forms a sealed joint between the substrate 1 and the cap 2.

By silicone, is means a polyorganosiloxane formed by a —Si—O— chain or lattice on which are attached organic complementary groups of the methyl (—CH₃) type for example, at the silicon atoms.

The silicone may also have an organic group attached to one of the silicon atoms through a chain of several carbons, as illustrated below in its vulcanized form, and referenced as (A), wherein y is an organic group, m varies between 1 and 25 and n between 0 and 1,000. This type of chemical product is sometimes called an organo-modified siloxane.

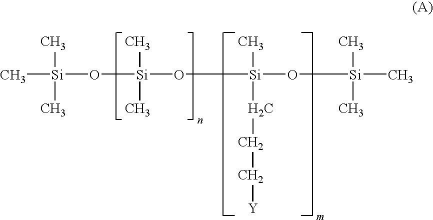

The adhesive may be based on a one-component or two-component silicone. It may also be fluorinated.

An adhesive base of fluorosilicone comprises chains based on siloxane (—Si—O—Si—O—), the branches of which bear fluorinated or perfluorinated groups of the —CF₃ type. This type of adhesive has a fluorine level varying between 20 and 60% for example.

As a non-limiting example, the adhesive based on silicone may be selected from the glues MED1511, MED6215, MED1-4013, MED-4013 marketed by Nusil Technology. The adhesive based on fluorosilicone may be FS3730 marketed by Nusil Technology.

It should be noted that the adhesives MED 1511 and FS 3730 surprisingly have better adhesive properties than the adhesive MED1-4013 on the hydrophobic layers described earlier.

MED 1511 and FS 3730 are one-component adhesives having a vulcanization mode by condensation (the catalyst being water) with release of acetic acid. Vulcanization may be carried out at room temperature.

MED1-4013 is a two-component glue which vulcanizes during the mixture of the two components wherein the catalyst is platinum. The vulcanization may be carried out at room temperature.

The vulcanization phenomenon may be defined as follows. A silicone adhesive consists of independent polymer chains. In the presence of a catalyst, its chains bind together through covalent bonds (this phenomenon is called cross-linking) most often with the release of a third product.

For one-component glues, ambient humidity is the most common catalyst.

For two-component adhesives, the catalyst is one of the components.

During vulcanization, the cross-linked adhesive becomes less plastic and more elastic.

The release of acetic acid during the vulcanization of the adhesive is due to the presence of an acetate radical in the chemical structure of the adhesive.

Also, preferably, the adhesive based on silicone is selected so at to include an acetate radical.

The making of a microfluidic device according to the first and second preferred embodiments will now be described in detail.

The substrate 1 includes a supporting layer 10, for example in SiO₂, preferably planar according to the first preferred embodiment of the invention.

The structuration of the electrodes 11 may be obtained by standard methods of microtechnologies, for examples by photolithography and etching. The electrodes 11 are for example made by depositing a metal layer (Au, Al, ITO, Pt, Cr, Cu, . . . ) by sputtering or evaporation.

The substrate 1 is then covered with a dielectric layer 12 in Si₃N₄, SiO₂, . . . .

Walls 30 are formed on the dielectric layer 12 at the border of the substrate 1 in order to delimit a microfluidic cavity, and possibly inside the latter, in order to define areas for displacement of the drops, according to the layout of the electrodes 11.

The walls 30 also allow definition of a specific positioning distance of the cap 2 relatively to the substrate 1.

According to the first preferred embodiment of the invention illustrated in FIG. 1, they may be formed in photosensitive resin deposited with a whirler, by deposition of a photosensitive film or polymer. Preferably, the walls 30 are made in Ordyl, for example SY300 marketed by Elga Europe.

According to the second preferred embodiment of the invention illustrated in FIG. 2, the walls 30 are formed in a single piece with the supporting layer by photolithography on thick resin deposited by spin-coating or dip-coating, photolithography or lamination of an adhesive film, possibly by screen-printing.

The thickness of the electrodes 11 is from a few tens of nanometers to a few microns, for example comprised between 10 and 1 μm. The width of the pattern of the electrodes 11 is from a few microns to a few millimeters (planar electrodes).

The two substrates 1 and 2 are typically distant by a distance comprised between for example 10 μm and 100 μm or 500 μm.

Regardless of the relevant embodiment, a drop of liquid will have a volume for example comprised between a few picoliters and a few microliters, for example between 1 pL or 10 pL and 5 μL or 10 μL.

Further, each of the electrodes 11 for example has a surface of the order of a few tens of μm² (for example 10 μm²) up to 1 mm², depending on the size of the drops to be transported, on the spacing between neighboring electrodes comprised between 1 μm and 10 μm for example.

The hydrophobic layer 13, 23 is obtained by a plasma-assisted chemical vapor deposition technique (PECVD), a technique known to one skilled in the art.

This technique is however optimized according to characteristics described in application WO 2007/003754 A1 filed in the name of the applicant.

The precursor preferably is octamethyl-cyclotetrasiloxane, also noted as OMCTS.

Moreover, the deposition conditions are the following, as described in patent application WO 2007/003754 A1.

The pressure in the deposition chamber may be comprised between 0.1 and 1 mbar, the RF power applied to the electrode generating the plasma may be comprised between 10 and 400 W, and the precursor flow rate may be comprised between 10⁻⁴ and 10⁻² mol/min. The helium flow rate may be comprised between 0 and 500 sccm.

Examples of deposition of the material as well as analyses on the properties of said material are detailed in patent application WO 2007/003754 A1.

The hydrophobic layers 13, 23 are formed with a material thereby having the conformation described earlier.

The layers 13, 23 are thus hydrophobic and have a contact angle of about 107°. Further, the wetting hysteresis is particularly small since it is less than 10°, or even less than 5°.

Further, the hydrophobic layer 13 is deposited at the surface of the substrate 1, more specifically at the surface of the dielectric layer 12 and of the walls 30, and has a substantially homogenous thickness.

The step for deposition of the hydrophobic layers 13, 23 is then directly followed by the step for adhesively bonding said substrates 1, 2.

According to the first and second preferred embodiments of the invention, the adhesive 31 may be deposited by any technique with which a localized thin layer of a viscous fluid may be obtained (flexography, heliography, deposition with pipettes), for example manually or automatically with a suitable device of the pipette type on one or both of the two hydrophobic layers 13, 23.

Alternatively, it may be deposited by a screen printing technique described in patent application WO 2004/112961 A1 filed in the name of the applicant.

In this case, the different assembly areas 15 of the hydrophobic layer 13 are preferably substantially coplanar.

The method for depositing the adhesive 31 consists of:

placing a grid above the substrate 1.

coating this grid with adhesive, by means of a tool (not shown) which, by pressing on the grid, locally puts this grid in contact with the assembly areas, so as to deposit a film of adhesive droplets on these assembly areas, and

removing the grid.

This screen-printing technique includes characteristics and alternatives described in the patent application mentioned earlier.

The silicone-based adhesive used in the screen-printing technique preferably represents thixotropic glues with a viscosity of 32,000 cP, for example the Delo-KatioBond glue of reference 45952 marketed by Delo. The glue FS3730, mentioned earlier, may also be suitable.

Preferably, the viscosity of the adhesive is comprised between 1,400 cP and 100,000 cP.

The grid used may be polyester fabric 150-31 marketed by Dubuit. The tool for coating the grid may be a doctor blade, for example the doctor blade PV 95A marketed by Aclathan.

Regardless of the technique for depositing the adhesive, the cap 2 is then flattened and held by clamping until complete vulcanization of the adhesive 31.

Finally, in order to ensure a better seal of the microfluidic device, an adhesive bead 31 may be deposited on the juncture of the substrate 1 and of the cap 2, and over the whole peripheral outer surface of the device, as described above with reference to FIG. 3. The bead may have a diameter substantially equal to the cumulated height of the assembled substrate 1 and cap 2, for example of the order of one millimeter.

The microfluidic device may then be filled with mineral oil or silicone, via orifices made in the cap 2 and opening out inside the microfluidic cavity.

Certain orifices may communicate with reservoirs of liquid samples, diluents, or reagents.

The device may be used for all biological, biochemical or chemical applications, notably for detection of pathogens.

According to the third preferred embodiment of the invention illustrated in FIG. 3, the substrates 1 and 2 are positioned relatively to each other so that the hydrophobic layers 13 and 23 are at least partially in mutual contact at the assembly areas 15 and 25.

A bead of adhesive 31 is deposited on the outer periphery of the juncture of the assembly areas 15, 25. The bead may have a diameter substantially equal to the cumulated height of the assembled substrate 1 and cap 2, for example of the order of one millimeter.

Tests were carried out for analyzing the breakage strength of the assembly of the substrates 1 and 2 of a microfluidic device according to the first preferred embodiment of the invention (FIG. 1).

For this, an orifice is provided in the cap 2 for communicating with the microfluidic cavity from the outside of the device.

This orifice is connected to the outlet of a syringe actuated by a syringe pump.

In these tests, the microfluidic cavity is sealably closed. It is connected to the syringe through the orifice of the cap, so that the pressure in the line connecting the syringe to the orifice corresponds to the pressure in the microfluidic cavity.

A pressure sensor is provided for measuring the imposed pressure. The pressure sensor is connected to the outlet of the syringe and measures the pressure in the line.

During these tests, the pressure in the microfluidic cavity is increased by small increments. A relaxation time of a few tens of seconds is provided, for example 25 seconds, before reading the value of the pressure.

As long as the cap and the substrate are sealably assembled with each other, the pressure in the microfluidic cavity increases linearly, depending on the number of increments of the syringe pump.

When there is breakage of the adhesive 31, the pressure in the microfluidic cavity suddenly drops. The maximum pressure supported by the adhesive before breakage may thereby be determined.

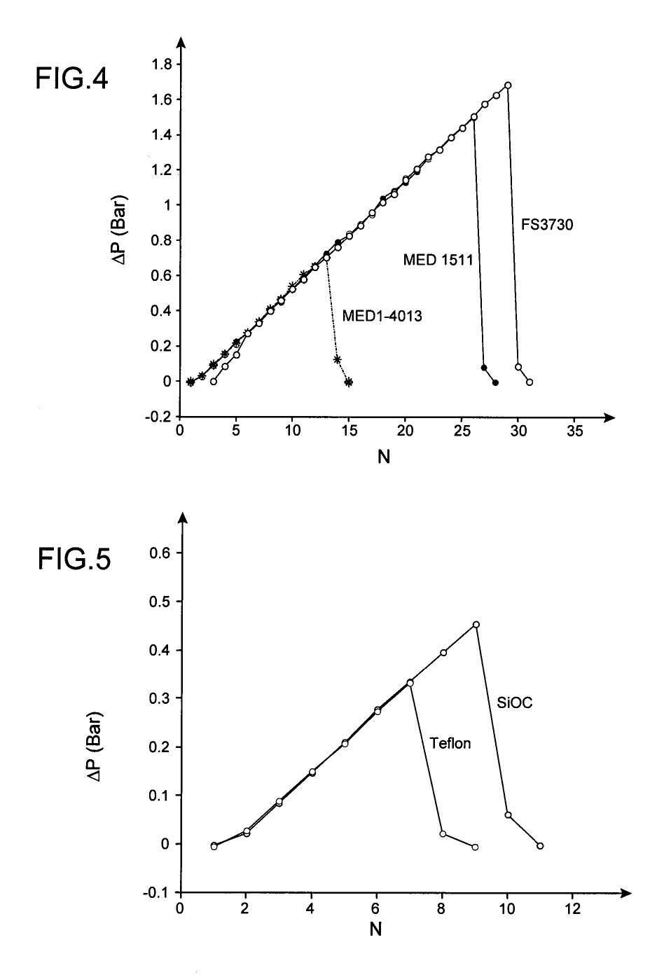

FIGS. 4 and 5 illustrate the results of breakage tests of the assembly of the substrates 1, 2, conducted with the experimental set-up described earlier.

FIG. 4 gives the time dependent change in the relative pressure ΔP versus the number of pressure increase increments by the syringe pump.

ΔP is the pressure difference between the pressure in the microfluidic cavity and a reference pressure, for example atmospheric pressure.

The hydrophobic layer is polysiloxane for which the ratio between the linear —Si—O— bonds and the cyclic —Si—O— bonds is less than or equal to 0.4. Different glues are tested, i.e. MED1-4013, MED-1511 and FS3730 mentioned earlier.

The results show a larger breakage resistance in the case of glues MED-1511 and FS3730 than in the case of the glue MED1-4013.

It is recalled that unlike the two-component glue MED1-4013, the glues MED-1511 and FS3730 are one-component glues which vulcanize by condensation with release of acetic acid. The release of acetic acid shows that the chains of polymers of these glues include an acetate radical.

It is therefore preferably to use an adhesive 31 based on silicone including an acetate radical and which therefore vulcanizes with release of acetic acid, such as glues MED-1511 and FS3730 for example.

FIG. 5 illustrates the time-dependent change of the pressure ΔP versus the number N of pressure increase increments by the syringe pump.

The experimental set-up is identical with the preceding one. However, for this test, the adhesive used is the MED-1511 glue mentioned earlier, and two materials for the hydrophobic layers 15, 25 are tested, i.e. Teflon®, and SiOC for which the ratio between the linear —Si—O— bonds and the cyclic —Si—O— bonds is less than or equal to 0.4.

The curve clearly shows better breakage strength of the adhesive based on silicone when the hydrophobic layers are based on polysiloxane than when they are based on fluorinated material such as Teflon®.

Finally, different non-silicone glues are tested with the experimental set-up described earlier. Assembly of the substrates 1 and 2 by adhesive bonding could not be obtained. The tested glues are the following:

epoxy glues: EPO-TEK® 353-ND, H70-E2, OG116 marketed by Epoxy Technology, 18S, 15X_{—}2 marketed by Master Bond Inc., E701 marketed by Epotecny, KB 45952, KB 554 and KB 4557 marketed by Syneo;

acrylic glues: Vitralit® 6108T, 9181, 5140, 6128 and 9181 marketed by Eleco;

araldite glues: Araldite® 2021 marketed by Huntsman;

polyurethane glues: DP5003 marketed by 3M, PU15 marketed by Henkel;

neoprene glue: Sader®;

cyanoacrylate glue: Loctite® 4014.

The latter test shows the significant and surprising synergy, in terms of adhesion, between the hydrophobic layers based on polysiloxane and the adhesives based on silicone.

Of course, various modifications may be made to the invention which has just been described, only as non-limiting examples, by one skilled in the art.

Moreover, the hydrophobic layers 13 and 23 may be formed with a polysiloxane deposited by other techniques, such a dip-coating or spin-coating, or even chemical vapor deposition (CVD).

In the latter case, the precursor may be selected from the non-limiting list comprising octamethyl-cyclotetrasiloxane and its derivatives, tetramethyl-cyclotetrasiloxane and its derivatives, hexamethyl-disiloxane and its derivatives, trimethylsilane and its derivatives, tetramethylsilane and its derivatives and bis-trimethylsilylmethane and its derivatives.

1. Microfluidic device comprising first and second substrates respectively including first and second hydrophobic layers based on polysiloxane, said hydrophobic layers each comprising an assembly area,
characterized in that said substrates are assembled with each other at the assembly areas of said hydrophobic layers by means of an adhesive based on silicone.

2. Microfluidic device according to claim 1, characterized in that said first substrate includes at least one wall arranged so as to delimit, together with said second substrate, a microfluidic cavity for fluid displacement, said wall being at least partially covered with said first hydrophobic layer.

3. Microfluidic device according to claim 2, characterized in that said first hydrophobic layer comprises a first surface forming a surface of fluid displacement, a second surface forming said assembly area and located at said wall, and a third surface connecting said first and second surfaces and located at said wall.

4. Microfluidic device according to claim 2, characterized in that said wall is an added element arranged at said first substrate or is integrally formed with said first substrate.

5. Microfluidic device according to claim 1, characterized in that said hydrophobic layers are based on polysiloxane for which the ratio between the linear —Si—O— bonds and the cyclic —Si—O— bonds is less than or equal to 0.4.

6. Microfluidic device according to claim 1, characterized in that said adhesive is a silicone elastomer.

7. Microfluidic device according to claim 1, characterized in that said adhesive is based on fluorosilicone.

8. Microfluidic device according to claim 1, characterized in that said adhesive is positioned between the assembly areas of said hydrophobic layers.

9. Microfluidic device according to claim 1, characterized in that the assembly areas of said hydrophobic layers are at least partially in mutual contact, said adhesive being located at the outer periphery of the juncture of said assembly areas.

10. Microfluidic device according to claim 1, characterized in that said first substrate comprises an array of electrodes covered with a dielectric layer, said first hydrophobic layer covering said dielectric layer, and in that said second substrate comprises a counter-electrode.

11. Method for assembling first and second substrates with each other, said substrates respectively including first and second hydrophobic layers based on polysiloxane, said hydrophobic layers each comprising an assembly area, said method being characterized in that it comprises a step for adhesively bonding said substrates to each other at the assembly areas of said hydrophobic layers by means of an adhesive based on silicone.

12. Assembling method according to claim 11, characterized in that, prior to said adhesive bonding step, said first and second hydrophobic layers are respectively formed at the surface of said first and second substrates by plasma-assisted chemical vapor deposition, into which a precursor selected from cyclic organosiloxanes and cyclic organosilazanes is injected, the ratio between the power density dissipated in the plasma and the precursor flow rate injected into the plasma being less or equal to 100 W·cm⁻²/mol·min⁻¹.

13. Assembling method according to claim 12, characterized in that the precursor is selected from octomethylcyclotetrasiloxane and its derivatives.

14. Assembling method according to claim 12, characterized in that said step for adhesively bonding said substrates is directly preceded with said step for depositing said first and second hydrophobic layers at the surface of said first and second substrates, respectively.

15. Assembling method according to claim 12, characterized in that said first substrate comprises at least one wall arranged so as to delimit, together with said second substrate, a microfluidic cavity for fluid displacement, said step for depositing said first hydrophobic layer being carried out so that said wall is at least partially covered with said first hydrophobic layer.

16. Assembling method according to claim 11, characterized in that said adhesive bonding step comprises a step for vulcanization of said adhesive with release of acetic acid.
